(19) United States
(12) Patent Application Publication
(10) Pub. No.: US 2025/0381619 A1
(43) Pub. Date: Dec. 18, 2025

(54) JET NOZZLE HAVING A POWDER UNIT AND PROCESS-GAS UNIT

(71) Applicant: TRUMPF Laser- und Systemtechnik SE, Ditzingen (DE)

(72) Inventors: Nicolai Speker, Pleidelsheim (DE); Björn Sautter, Leonberg (DE); Andreas Scholz, Taunusstein (DE); Stefan Belitz, Stuttgart (DE); Arne Steck, Remseck am Neckar (DE); Jakob Spiecker, Stuttgart (DE); Fabian Goetzelmann, Leonberg (DE); Tim Hesse, Ditzingen (DE); Holger Braun, Renningen (DE)

(21) Appl. No.: 19/318,392

(22) Filed: Sep. 4, 2025

Related U.S. Application Data
(63) Continuation of application No. PCT/EP2024/056035, filed on Mar. 7, 2024.

(30) Foreign Application Priority Data
Mar. 9, 2023 (DE) 10 2023 105 831.2
Sep. 4, 2023 (DE) 10 2023 123 703.9

(51) Int. Cl. B23K 26/14; B23K 26/144; B23K 26/342; B23K 101/34; B33Y 80/00

(52) U.S. Cl. CPC B23K 26/147; B23K 26/144; B23K 26/342; B23K 2101/34; B33Y 80/00

(57) ABSTRACT

A jet nozzle for laser deposition welding in an advance direction includes a light channel for guiding at least one laser beam to be directed at a workpiece, and a powder unit arranged radially outside the light channel for guiding at least one powder jet to be applied to the workpiece. The powder unit forms a powder portion in a peripheral direction around the light channel. The jet nozzle further includes a process-gas unit arranged radially outside the light channel for guiding a process gas. The process-gas unit forms a process-gas portion in the peripheral direction. The process-gas portion adjoins the powder portion at a nozzle mouth in the peripheral direction.

### CROSS REFERENCE TO RELATED APPLICATIONS

This application is a continuation of International Application No. PCT/EP2024/056035 (WO 2024/184465 A1), filed on Mar. 7, 2024, and claims benefit to German Patent Application No. 10 2023 105 831.2, filed on Mar. 9, 2023 and German Patent Application No. 10 2023 123 703.9, filed on Sep. 4, 2023. The aforementioned applications are hereby incorporated by reference herein.

### FIELD

Embodiments of the present invention relate to a jet nozzle for laser deposition welding in an advance direction.

### BACKGROUND

Laser deposition welding is used in the fields of repair, coating, and/or joining technology, for example. A distinction can be made between conventional laser deposition welding techniques (laser metal deposition (LMD), direct metal deposition (DMD) or direct energy deposition (DED)), and high-speed laser deposition welding (HS-LMD) or extreme high-speed laser application (EHLA)). HS-LMD methods are described, for example, in published patent applications DE 10 2011 100 456 A and DE 10 2018 130 798 A1. Another method for laser deposition welding is known from the Chinese patent application CN 109175372 A.

A functional layer may be applied to a workpiece by means of laser deposition welding. This generally increases the load-bearing capacity of the workpiece processed by means of laser deposition welding compared to an unprocessed workpiece. The functional layer may serve as a wear protection layer, for example. The application of the functional layer is based on a melting of a workpiece surface, an application of a powdered filler material, and a subsequent cooling so that a matrix structure with hard material particles is materially bonded to the material surface. Laser deposition welding therefore engages with the inner material structure of the workpiece and changes it. Under certain circumstances, this can result in imperfections in the internal material structure. These can impair the desired increase in load-bearing capacity. The imperfections can be of a microscopic nature, which is why they can only be identified with great effort.

### SUMMARY

Embodiments of the present invention provide a jet nozzle for laser deposition welding in an advance direction. The jet nozzle includes a light channel for guiding at least one laser beam to be directed at a workpiece, and a powder unit arranged radially outside the light channel for guiding at least one powder jet to be applied to the workpiece. The powder unit forms a powder portion in a peripheral direction around the light channel. The jet nozzle further includes a process-gas unit arranged radially outside the light channel for guiding a process gas. The process-gas unit forms a process-gas portion in the peripheral direction. The process-gas portion adjoins the powder portion at a nozzle mouth in the peripheral direction.

### BRIEF DESCRIPTION OF THE DRAWINGS

Subject matter of the present disclosure will be described in even greater detail below based on the exemplary figures. All features described and/or illustrated herein can be used alone or combined in different combinations. The features and advantages of various embodiments will become apparent by reading the following detailed description with reference to the attached drawings, which illustrate the following:

FIG. 1 shows a schematic view of a jet nozzle during laser deposition welding according to some embodiments;

FIG. 2 shows a side view of a jet nozzle according to some embodiments;

FIG. 3 shows a perspective view of the jet nozzle from FIG. 2 according to some embodiments;

FIG. 4 shows the jet nozzle from FIG. 2 connected to other components according to some embodiments;

FIG. 5 shows a top view of a distal region of the jet nozzle from FIG. 2 according to some embodiments;

FIG. 6 shows a top view of a flange portion of the jet nozzle from FIG. 2 according to some embodiments;

FIG. 7 shows another perspective view of the jet nozzle from FIG. 2 according to some embodiments;

FIG. 8 shows a perspective sectional view of the jet nozzle from FIG. 2 according to some embodiments;

FIG. 9 shows a top view of a distal region of the jet nozzle with a process-gas unit according to some embodiments;

FIG. 10 shows a top view of the distal region of the jet nozzle with the process-gas unit, with a powder focus corresponding to a focus of a primary laser beam, according to some embodiments;

FIG. 11 shows a perspective view of the jet nozzle with the process-gas unit according to some embodiments;

FIG. 12 shows a side view of the jet nozzle with the process-gas unit according to some embodiments;

FIG. 13 shows further representations of the jet nozzle with the process-gas unit;

FIG. 14 shows a side view of a further embodiment of the jet nozzle with a geometrically adapted nozzle mouth according to some embodiments; and

FIG. 15 shows a top view of a further embodiment of the jet nozzle with a geometrically adapted nozzle mouth according to some embodiments.

### DETAILED DESCRIPTION

Embodiments of the present invention provide an improved jet nozzle for laser deposition welding in an advance direction. Embodiments of the invention can increase the welding quality of a deposited functional layer and of the workpiece as a whole, and to reduce or avoid imperfections in a welded joint between a powdered filler material and a material surface. The imperfections can be bonding defects between the material surface and the applied functional layer or between individual applied functional layers. The imperfections can also be pores, i.e., air pockets, which occur within the applied functional layer, or between the applied functional layer and the material surface. Particularly if the material surface is a cast material, pores can occur more frequently. The imperfections can also be cracks that run vertically to the material surface within the applied functional layer. The imperfections can also result from the fact that powder particles, in particular carbides, of the powdered filler material dissolve in a matrix material of the powdered filler material, which leads to the matrix material becoming brittle. Embodiments of the invention also provide a reliable jet nozzle that is resistant to thermal stresses. Embodiments of the invention can also design the jet nozzle in such a way that it ensures reliable and precise laser deposition welding over a very high number of cycles.

Accordingly, a jet nozzle for laser deposition welding in an advance direction is proposed, which has a light channel for conducting at least one laser beam, which is directed at a workpiece. Laser deposition welding can be a method for high-speed laser metal deposition (HS-LMD). The advance direction is the direction along which the jet nozzle moves relative to the workpiece. It can result from a movement, in particular a rotational movement, of the workpiece, from a movement of the jet nozzle, or from a superposition of both movements. The advance direction and the correlating advancement movement can be constant over the course of the process. Alternatively, they can vary with the respective process stage. The workpiece can be a rotationally symmetrical workpiece, such as a brake disk, a hydraulic cylinder, a pressure roller, or a plain bearing. The laser beam can shine through the light channel. It can be provided by a laser source, from which the laser beam is guided by means of an optical fiber cable to a laser system that splits the laser beam via a collimating lens and focuses it in line with the process via laser optics before it enters the jet nozzle. The light channel can be a hollow channel that runs through the entire jet nozzle along a longitudinal direction. In addition to the laser beam, a process gas can also be directed to the workpiece surface through the light channel.

The jet nozzle further has a powder unit arranged radially outside the light channel for guiding at least one powder jet which is to be applied to the workpiece, wherein the powder unit forms a powder portion in a peripheral direction around the light channel. Starting from the longitudinal direction of the jet nozzle, the powder unit may be radially outside the light channel and may be part of an outer structure that surrounds the light channel in a closed manner. The powder jet may convey at least one powdered filler material consisting of hard material particles, in particular carbides, and a matrix material. The powder unit may be the part of the jet nozzle that is provided to directly or indirectly conduct the powdered filler material. The powder unit may have injector guides into which powder injectors can be inserted. It may also have an annular gap within which the powdered filler material is conducted. At the nozzle mouth, the powder unit forms a powder portion in a peripheral direction around the light channel. The powder unit may be part of the nozzle mouth. The nozzle mouth is the part of the jet nozzle facing the workpiece. The end portion of the nozzle mouth has a distal region. This is the part of the nozzle mouth that is closest to the workpiece. At the portion remote from the workpiece, the jet nozzle has a proximal region and a flange portion. The proximal region and the flange portion are the part of the jet nozzle facing away from the workpiece. The nozzle can be coupled to a further component of the laser system, such as laser optics or a process unit, via the flange portion. In the top view, the powder portion may run at least in sections along the opening of the light channel.

The jet nozzle further has a process-gas unit arranged radially outside the light channel for guiding a process gas, wherein the process-gas unit forms a process-gas portion in the peripheral direction. Starting from the longitudinal direction of the jet nozzle, the process-gas unit can be radially outside the light channel and can be part of the outer structure that surrounds the light channel in a closed manner. The process gas can positively influence the powder caustic and the workpiece processing caused thereby. The process-gas unit may be the part of the jet nozzle that is provided to guide the process gas directly or indirectly. The process-gas unit may have injector guides into which additional injectors can be inserted. It may also have an annular gap, within which the process gas is guided. At the nozzle mouth, the process-gas unit forms the process-gas portion in a peripheral direction around the light channel. The process-gas unit may be part of the nozzle mouth. In the top view, the process-gas portion may run at least in sections along the opening of the light channel. The process-gas portion may be the part of the process-gas unit from which the process gas emerges from the jet nozzle.

The process-gas portion connects to the powder portion at the nozzle mouth in the peripheral direction. This means that the process-gas portion is directly adjacent to the powder portion in the peripheral direction. This allows the process gas to have a stabilizing effect on the powder caustic and the continuous laser deposition welding. The process-gas portion may be connected to the powder portion in such a way that a transition takes place in the peripheral direction so that an interior is separated from the process-gas portion and the powder portion from an exterior. The separation may be such that as little fluid as possible is exchanged between the inside and the outside. This can help to stabilize the process zones, and at the same time prevent the powder particles from sticking to one end face of the jet nozzle, thus increasing the service life of the jet nozzle.

The jet nozzle may thus provide increased variability in (i) laser beam guidance, (ii) the use of a powdered filler material, (iii) heat management, (iv) protection of the laser system including the jet nozzle. It enables the provision of a plurality of independent process zones with high precision. The process zones can be divided into zones for laser deposition welding and zones for pre- and/or post-processing. In the zones for laser deposition welding, an interaction takes place between at least one laser beam and a powdered filler material. The pre-processing and/or post-processing may be the cleaning of the material surface, the pre-heating of the material surface before the powdered filler material is applied, the post-heating of the material surface after the powdered filler material has been applied, or a combination thereof. During pre-processing and/or post-processing, the laser beam may strike the workpiece without interacting with the powdered filler material. The independent process zones can increase the welding quality and thus the load-bearing capacity of the applied functional layer, in particular the wear protection layer, and of the workpiece as a whole. An additional process gas may stabilize the process zones and increase the precision of laser deposition welding as well as the service life of the jet nozzle.

In particular, the jet nozzle may reduce the occurrence of bonding defects. This is because bonding defects can occur if the surface heated by the laser beam, such as when the workpiece or a previously welded-on functional layer, has not been sufficiently heated. This lack of heating can be the result of the laser power of a single laser beam being kept low to avoid overheating the powdered filler material. Due to the increased variability of laser beam guidance, the increased variability of the application of a powdered filler material and/or the increased variability of heat management of the jet nozzle, the occurrence of bonding defects may be reduced or even prevented, in particular by stabilizing the process-gas portion, which is arranged in the peripheral direction adjacent to the powder portion, the laser beam guide and/or the powder caustic.

In particular, the jet nozzle can also reduce the occurrence of pores between the welded-on functional layer and the surface heated by the laser beam. This is because pores can occur when lamellae in the workpiece, in particular graphite lamellae, are vaporized by the laser radiation. Pores can also occur if the surface to be machined has impurities, for example caused by oils, greases, cooling lubricants or oxides, which cannot be completely removed by the welding process. The undesired vaporization of the impurities can be the result of the laser power of a single laser beam being set so high that bonding defects due to insufficient heating can be avoided. Due to the increased variability of laser beam guidance, the increased variability of the application of a powdered filler material and/or the increased variability of heat management of the jet nozzle, the occurrence of pores may be reduced or even prevented, in particular by stabilizing the process-gas portion, which is arranged in the peripheral direction adjacent to the powder portion, the laser beam guide and/or the powder caustic.

In particular, the jet nozzle can also reduce the occurrence of cracks in the welded-on functional layer. This is because cracks can occur if a temperature gradient between the highly heated powdered filler material and the less strongly heated workpiece surface is so strong that the material shrinkage that occurs during cooling results in stresses that cause cracks. Cracking can be the result of a laser power of a single laser beam being set so high that bonding defects due to insufficient heating can be avoided. Due to the increased variability of laser beam guidance, the increased variability of the application of a powdered filler material and/or the increased variability of heat management of the jet nozzle, the occurrence of cracks may be reduced or even prevented, in particular by stabilizing the process-gas portion, which is arranged in the peripheral direction adjacent to the powder portion, the laser beam guide and/or the powder caustic.

In particular, the jet nozzle can also reduce the dissolution of hard material particles, in particular carbides, in the matrix material. The powdered filler material can contain hard material particles, in particular carbides, and a matrix material. The hard material particles should be present undissolved in the welded-on functional layer to increase the load-bearing capacity of the functional layer. However, hard material particles can dissolve if the powdered filler material is exposed to too high a radiation intensity, causing the hard material particles to melt. Dissolved hard material particles cause the welded-on functional layer to become brittle because the matrix material is less ductile, which means that stresses caused by shrinkage, for example, cannot be absorbed by the matrix material when the workpiece is cooled or loaded. Due to the increased variability of laser beam guidance, the increased variability of the application of a powdered filler material and/or the increased variability of heat management of the jet nozzle, the dissolution of hard material particles may be reduced or even prevented, in particular by stabilizing the process-gas portion, which is arranged in the peripheral direction adjacent to the powder portion, the laser beam guide and/or the powder caustic.

In particular, the jet nozzle can prevent an adhesion of powder particles to the nozzle mouth. In principle, high process heat, reflective laser radiation, and/or a metal vapor plume can cause an adhering or even welding of filler material to the nozzle mouth, which can disrupt the gas and powder flows and subsequently impair the process result. The metal vapor plume is a result of the partial vaporization of the material due to the laser deposition welding. It can lead to scattering and/or absorption of laser radiation and consequently impair the preheating of the workpiece. This may further promote the formation of bonding defects. Due to the increased variability of laser beam guidance, the increased variability of the application of a powdered filler material and/or the increased variability of heat management of the jet nozzle, the undesirable dissolution of hard material particles and propagation of the metal vapor plume may be reduced or even prevented, in particular by stabilizing the process-gas portion, which is arranged in the peripheral direction adjacent to the powder portion, the laser beam guide and/or the powder caustic.

At least one laser beam, in particular at least one circular laser beam and/or one oval laser beam, can be guided within the nozzle mouth in such a way that, in interaction with the powdered filler material, more than one process zone is formed, which promotes welding behavior, reduces the imperfections of the welded joint, in particular the occurrence of bonding defects, pores, cracks and/or the dissolution of carbides in the matrix material, and increases the load-bearing capacity of the applied functional layer. By providing the process-gas unit, the process zones can be influenced in a targeted manner. On the one hand, this prevents powder particles from sticking or even welding to the nozzle mouth. Secondly, the propagation of the vapor plume can be prevented by keeping it in the area between the nozzle mouth and the workpiece, especially within the powder portion and the process-gas portion. Thus, the process-gas portion contributes to reducing the aforementioned imperfections.

In one embodiment, the process-gas unit forms at least one outlet opening on one end face of the jet nozzle, from which the process gas can be fed to the workpiece, wherein an additional injector for supplying the process gas without filler material is arranged in the at least one outlet opening. The outlet opening can be designed on the end face in such a way that the surface to which hard material particles can adhere is minimized. The process gas that is fed out of the outlet opening can be supported by the process gas that is fed inside the light channel. An additional injector may be arranged in each outlet opening. The additional injector differs from the injectors arranged in the injector guides of the powder unit. The latter transport the hard material particles to the workpiece surface, while the former transport the process gas.

In one embodiment, the process-gas portion extends at least in sections along an arc of a slotted hole, in particular in an arcuate shape, around the light channel. Similar to a circular arc, the arc of a slotted hole represents a line surrounding the slotted hole in a sector. The remaining part of the slotted hole that is not covered by the slotted hole arc along which the process-gas portion extends can be filled by the powder portion. The process-gas portion can extend at least partially along a partial circular section, in particular the partial circular section that lies at the front in the advance direction, to form the arc shape. This also helps to stabilize the laser beam guidance and/or the powder caustic.

In one embodiment, the process-gas portion extends in the peripheral direction around the light channel over a wrap angle of between 5° and 180°, in particular between 45° and 120°, relative to a center point of the light channel. This means that the process-gas portion can extend around the light channel by a smaller section than the powder portion. This ensures a satisfactory supply of powder through the powder unit and, in particular, the injectors arranged therein, while avoiding adhesion or spreading of the vapor plume. Precise adaptation of the powder portion and the process-gas portion to the respective process conditions enables efficient welding behavior without imperfections.

In one embodiment, the process-gas portion and the powder portion together completely surround the light channel in the peripheral direction, i.e., by 360°. The jets emerging from the process-gas portion and the powder portion can thus separate an interior, which is formed inside the jets, and an exterior, which is formed outside the jets. The metal vapor plume, also known as a vapor plume, resulting from the interaction of the powder particles with the laser beam cannot escape from the interior in this way, which prevents unwanted interaction of the vapor plume with the workpiece.

In one embodiment, the process-gas unit has a feed opening, through which the process gas can be supplied to the process-gas unit, and the process-gas unit has at least one outlet opening through which the process gas exits the process-gas unit. The feed opening may be coupled to a feed hose that directs the process gas from a gas reservoir to the jet nozzle. The process-gas unit may have exactly one feed opening. The at least one outlet opening is fluidically connected to the feed opening and is shaped such that a process-compliant discharge of the process gas towards the workpiece surface is ensured. Between the feed opening and the at least one outlet opening, at least one distribution arm is provided which guides the process gas. An additional injector may be provided in the distribution arm and/or in the outlet opening. Alternatively, the process gas may exit directly from the distribution arm and/or the outlet opening.

In one embodiment, the process-gas unit has a plurality of, in particular three, outlet openings, which are each connected to the one feed opening. The plurality of outlet openings ensures distribution of the process gas along the peripheral direction. As an alternative to the plurality of outlet openings, an arc-slot-like outlet opening may also be provided, which also ensures distribution of the process gas along the peripheral direction. The plurality of outlet openings contributes to stabilizing the vapor plume and preventing powder particles from adhering to the nozzle mouth.

In one embodiment, the process-gas portion is formed in a region of the nozzle mouth facing the advance direction. In a top view, the region of the nozzle mouth facing the advance direction is provided at the end of the nozzle that is close to the advance direction. One end face of the process-gas portion points in the direction of the workpiece. The process-gas portion may extend along the peripheral direction around the light channel in an angular range. The angular range over which the process-gas portion extends may be smaller than the angular range over which the powder portion extends. The region in which the process-gas portion is formed may correlate with the position and orientation of the powder injectors that apply the powdered filler material to the workpiece.

In one embodiment, the powder portion has a plurality of injector guides, into each of which a powder injector may be inserted. The injector guides may be cylindrical or conical through-openings in the region of the nozzle mouth, into each of which a powder injector may be inserted. The injector guides may be introduced into the nozzle mouth by machining. Preferably, however, they are provided at the stage of additive manufacturing of the jet nozzle. The injector guides may be adapted to the powder injector to be used. The injector guides of the powder portion differ from the distribution arms of the process-gas portion. The powder injectors also differ from the additional injectors that deliver the process gas.

In one embodiment, an inner diameter of at least one outlet opening is smaller than an inner diameter of the injector guides. The volume flow of the process gas can be influenced via the inner diameter of at least one outlet opening. A gas flow rate of process gas through the at least one outlet opening can be in the range between 1 l/min and 100 l/min, in particular between 5 l/min and 50 l/min. The gas flow rate of conveying gas flowing out of the powder injectors in the injector guides and of process gas flowing out of the at least one outlet opening may be substantially equal. It is also possible for process gas to exit the light channel in addition to the outlet openings. The gas flow rates of the conveying gas and the process gas may also be weighted against each other. For example, the proportion of conveying gas may be greater than that of process gas or vice versa. The respective ratio of process gas to conveying gas can be adjusted depending on the process.

In one embodiment, a first powder injector is prepared to convey a first powder mass flow and a second powder injector is prepared to convey a second powder mass flow, wherein the first powder mass flow differs from the second powder mass flow. The first powder injector may be provided in a first powder portion, and the second powder injector may be provided in a second powder portion. The first powder injector may be arranged in such a way that it interacts with the primary beam of the laser beam. The second powder injector may be arranged in such a way that it interacts with the secondary beam of the laser beam. The primary beam and the secondary beam may be identical to one another or transport different energies. Provision of the first powder mass flow and the second powder mass flow enables the jet nozzle to achieve more than one process zone, which further contributes to increased variability of the jet nozzle. The gas flow rate exiting the at least one outlet opening outlet may be adjusted according to the first powder mass flow of the second powder mass flow.

In one embodiment, the powder portion forms an annular gap segment, in particular instead of injector guides. The annular gap segment may form a uniform powder focus which, for example, coincides with the center point of the at least one laser beam. In the case of an annular gap segment, the powdered filler material is applied to the workpiece along a horseshoe-shaped jet.

In one embodiment, the light channel is adapted to guide a plurality of laser beams, wherein the plurality has a first laser beam as a primary beam and a second laser beam as a secondary beam. The primary beam and the secondary beam may originate from the same optical fiber cable. The laser light provided may be split into a parallel beam via a collimating lens. The beam bundle may, for example, form the primary beam and the secondary beam from a single laser beam using a wedge plate. In this case, the primary beam and the secondary beam may have the same wavelength and transport the same energy. Alternatively, the primary beam and the secondary beam may differ in terms of their wavelength and energy. The respective center points of the primary beam and the secondary beam may be offset in line with a center point of the light channel in the advance direction.

In one embodiment, the jet nozzle is manufactured by means of an additive manufacturing process, in particular by means of powder bed fusion. For this purpose, the jet nozzle may be made of copper or a copper alloy, in particular a copper-chromium-zirconium alloy. This is suitable for additive manufacturing processes on the one hand and ensures sufficient strength, thermal conductivity, and heat resistance to withstand the process requirements on the other. In powder bed fusion, the material to be processed is in powder form. A laser beam heats the powder along the provided geometry, causing the powder to liquefy and form a material bond. The powder bed fusion may be formed using selective laser melting (SLM) or selective laser sintering (SLS), for example.

In one embodiment, the nozzle mouth has a chamfer by which a part of the nozzle mouth is cut off, wherein the chamfer is substantially planar and extends in a plane which is inclined relative to the longitudinal direction of the jet nozzle. The chamfer may cut off the powder portion and the powder portion-free advance section or the process-gas portion in the peripheral direction around the light channel. The chamfer reduces the volume of the nozzle mouth compared to the embodiment in which no chamfer is provided. This means that the nozzle mouth takes up less installation space. The jet nozzle with the chamfer may be used, for example, to coat a brake disk that has a mount that protrudes axially from the functional surface to be coated. The chamfer ensures that the jet nozzle can move flexibly on the functional surface to be coated and can be moved close to the holder. The chamfer may run in the distal region in the manner of a passant on the slotted hole. The passant defines the orientation of the chamfer on the nozzle mouth. In the end face of the jet nozzle facing the workpiece, the passant runs along a straight line or an arc that neither intersects nor touches the slotted hole. The distance of the passant from the center point of the light channel is greater than the distance of the corresponding section of the slotted hole from the center point of the light channel. The distance between the passant and an outer edge of the slotted hole is selected in such a way that the wall thickness in between ensures sufficient sturdiness and load-bearing capacity of the jet nozzle.

In one embodiment, the jet nozzle is adapted to guide the laser beam along the longitudinal direction of the jet nozzle, so that the at least one laser beam is orthogonal to the cross-sectional area. Furthermore, the light channel can be adapted to guide a shielding gas along a radially outer portion to shield a process zone.

The features according to the disclosure contribute partly on their own and partly in combination to overcoming the imperfections of laser deposition welding mentioned at the outset.

### DETAILED DESCRIPTION OF PREFERRED EXEMPLARY EMBODIMENTS

Preferred exemplary embodiments are described below with reference to the figures. In this case, elements that are the same, similar, or have the same effect are provided with identical reference symbols in the different figures, and a repeated description of these elements is omitted in some instances to avoid redundancies.

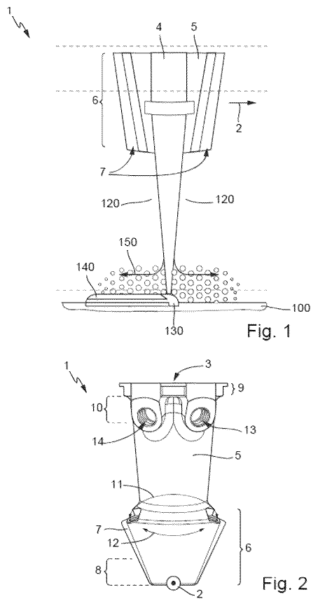

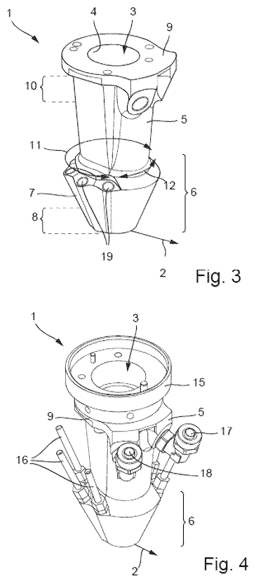

FIG. 1 shows a jet nozzle 1 for laser deposition welding in an advance direction 2. The advance direction 2 is the direction along which the jet nozzle 1 moves relative to a workpiece 100. It can result from a movement, in particular a rotational movement, of the workpiece 100, from a movement of the jet nozzle 1 or from a superimposition of a movement of the workpiece 100 and the jet nozzle 1. The advance direction 2 and the correlating advance movement may be constant over the course of the process. Alternatively, they may vary with the respective process stage. The workpiece 100 may be a rotationally symmetrical workpiece, such as a brake disk, a hydraulic cylinder, a pressure roller, or a plain bearing. At least one laser beam 110 emerges from a light channel 3 with a lateral surface 4. The light channel 3 can also be adapted to guide a process shielding gas 150 along a radially outer portion to shield a process zone and prevent oxidation. The light channel 3 is surrounded by an outer structure 5, which has a nozzle mouth 6, which in turn contains a powder unit 7. The powder unit 7 can, for example, have a plurality of injector guides 19 (see FIG. 3), into each of which can be inserted a powder injector 16 (see FIG. 4). As an alternative to the individual injector guides 19, the powder unit 7 can have an annular powder gap channel. A powdered filler material 120 is directed at the workpiece 100 via the powder unit 7 and the powder injectors 16 arranged therein. The laser beam 110 heats the workpiece 100 in such a way that a weld pool 130 forms on a material surface. In addition, the laser beam 110 heats the powdered filler material 120, which has hard material particles and a matrix material. For this purpose, the laser beam 110 can have a reduced core intensity. As soon as the weld pool 130 cools down, a welded-on functional layer 140, for example a wear protection layer, is formed from the hard material particles and the matrix material. The welded-on functional layer 140 makes the material surface more resistant and increases its load-bearing capacity.

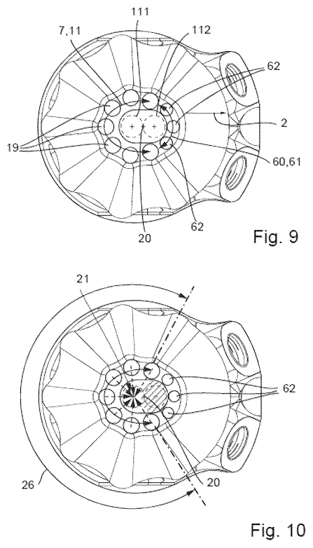

FIG. 2 shows the jet nozzle 1 in a side view, with the advance direction 2 pointing out of the drawing plane. The jet nozzle 1 may be coupled to other components of a laser system, such as laser optics or a process adapter, via a flange portion 9. A proximal region 10 is attached to the flange portion 9. A coolant inlet 13 and a coolant outlet 14, which are part of a cooling system of the jet nozzle 1 and which project radially from the jet nozzle 1, can be provided at least partially in the proximal region 10. A distal region 8 is formed at the end of the jet nozzle 1 opposite the proximal region 10. The distal region is part of the funnel-shaped nozzle mouth 6. In a peripheral direction around the light channel 3, this has a powder portion 11 in sections, in which the powder unit 7 is arranged. The powder portion 11 is followed in the peripheral direction by a powder unit-free advance portion 12. The advance portion 12 can be designed as a process-gas portion 61 (see, for example, FIG. 9), which is part of a process-gas unit 60.

FIG. 3 shows a perspective view of the jet nozzle from FIG. 2. The light channel 3 is a hollow channel with a lateral surface 4, within which runs the at least one laser beam 110. The outer structure 5 surrounds the light channel 3 from the flange portion 9 to the distal region 10. The nozzle mouth 6 is a substantially funnel-shaped region of the jet nozzle 1. The funnel shape of the nozzle mouth 6 serves, among other things, to enable the nozzle mouth 6 to form the plurality of injector guides 19 in the region of the powder unit 7. A powder injector 16 (see FIG. 4) is inserted into each of these injector guides 19, which directs the powdered filler material 120 onto the at least one laser beam 110 and/or the workpiece 100 in accordance with the process. The powder unit 7 extends along the powder portion 11, which is connected in the peripheral direction to the powder unit-free advance portion 12. The advance portion 12 is the region of the nozzle mouth 6 in which no injector guides 19 are provided, so that no powdered filler material 120 is supplied through it. In one embodiment, the advance portion 12 can be shaped as a process-gas portion 61, so that a process gas is supplied through it. The jet nozzle 1 can be manufactured by means of additive manufacturing processes, in particular by means of powder bed fusion. For this purpose, the jet nozzle 1 may be made of a copper-chromium-zirconium alloy. This is suitable for additive manufacturing processes on the one hand and ensures sufficient strength, thermal conductivity, and heat resistance to withstand the process requirements on the other. In powder bed fusion, the material to be processed is in powder form. A laser beam heats the powder along the provided geometry, causing the powder to liquefy and form a material bond. The powder bed fusion may be formed using selective laser melting (SLM) or selective laser sintering (SLS), for example.

FIG. 4 shows the jet nozzle 1, to which additional components are attached. A coupling ring 15 is connected to the flange portion 9, which attaches the jet nozzle 1 to the connected unit, for example the laser optics or the process adapter. Powder injectors 16 are inserted into the injector guides 19 of the powder unit 7. The powdered filler material 120 is conveyed by means of the powder injectors 16 and applied to the workpiece 100 with the provided focus. The individual powder injectors 16 may use different powder foci in relation to each other. Alternatively, the powder injectors 16 may be directed to the same focus point. The powder injectors 16 are arranged in the provided injector guides 19 of the powder unit 7 in the powder portion 11. The advance portion 12 is free of powder injectors 16. An inlet connection 17 is also inserted into the coolant inlet 13 and an outlet connection 18 is inserted into the coolant outlet 14. These connect the coolant inlet 13 and the coolant outlet 14 to a coolant circuit.

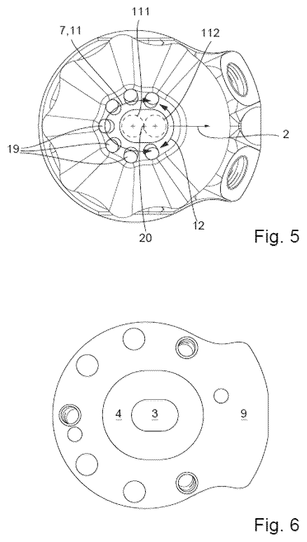

FIG. 5 shows the jet nozzle 1 in a top view of the distal region 8. The cross-sectional area of the light channel 3, which is orthogonal to the longitudinal direction of the jet nozzle 1, deviates from a circular shape and is stretched in the advance direction 2. In the distal region 8, the cross-sectional area of the light channel 3 is designed in the form of a slotted hole, in which two opposite ends of a rectangular portion are each joined by a partial circular portion. Two laser beams, a primary beam 111 and a secondary beam 112, are guided within the light channel 3. The primary beam 111 and the secondary beam 112 may originate from the same optical fiber cable. The laser light provided may be split into a parallel beam via a collimating lens. The beam bundle may, for example, form the primary beam 111 and the secondary beam 112 from a single laser beam using a wedge plate. The respective center points of the primary beam 111 and the secondary beam 112 are offset in the advance direction 2 from a center point 20 of the light channel 3 along a common line.

In the present case, the secondary beam 112 is positioned ahead of the primary beam 111 in the advance direction 2 and does not interact with a powder caustic. The secondary beam 112 may thus be used to preheat the workpiece 100 before the primary beam 111 and the powdered filler material 120, heated by the primary beam 111, impinge on the workpiece 100. The secondary beam 112 thus creates a first process zone, which serves to preheat the workpiece 100, and the primary beam 111 creates a second process zone, which serves to weld the powdered filler material 120 onto the workpiece 100. These different process zones enable a flawless weld in which no imperfections occur, in particular no bonding defects, pores, cracks and/or dissolution of carbides in the matrix material. It is also possible to guide the secondary beam 112 in the advance direction 2 after the primary beam 111. Thus, the secondary beam 112 can be used to reheat the workpiece 100, contributing to a more uniform cooling that prevents the occurrence of entrapment or other imperfections.

The primary beam 111 and the secondary beam 112 are arranged in close proximity to each other. The front partial circular-arc portion of the slotted hole in the advance direction 2 is concentric with the secondary beam 112, while the rear partial circular-arc portion of the slotted hole is concentric to the primary beam 111. A area centroid of the cross-sectional area is eccentric relative to a center point of the primary beam 111 and to a center point of the secondary beam 112. A tertiary beam may further be provided so that, for example, the secondary beam is arranged ahead of the primary beam in the advance direction and the tertiary beam is arranged behind the primary beam in the advance direction. The individual laser beams are guided to each other without shielding, so that there is exactly one light channel 3 with exactly one lateral surface 4, which results in minimal thermal losses.

Because the primary beam 111 in FIG. 5 is arranged behind the secondary beam 112 in the advance direction 2 without radial offset and the secondary beam 112 serves to preheat the workpiece, it is desirable that the powdered filler material does not interact with the secondary beam 112. This ensures that, on the one hand, the secondary beam 112 can only perform the function of preheating the workpiece and, on the other hand, the powdered filler material is only heated by the primary beam 111 and not by the secondary beam 112. This is achieved by the jet nozzle 1 shaping the powder unit 7 in the region of the nozzle mouth 6 in such a way that it forms the powder portion 11 in the peripheral direction around the light channel 3, to which the powder unit-free advance portion 12 is connected in the peripheral direction. In addition to the powder unit 7, the process-gas unit 60 can also be formed, which forms the process-gas portion 61, in which case the advance portion 12 is formed as the process-gas portion 61. The advance portion 12 is formed in a region of the nozzle mouth 6 facing the advance direction 2. The powder portion 11 extends along the slotted hole that forms the cross-sectional area of the light channel 3 in the distal region 8. Similar to a circular arc, the powder portion 11 extends along an arc of a slotted hole, in particular in the shape of a horseshoe, around the light channel 3. The powder portion 11 therefore extends in the peripheral direction around the light channel 3 over a wrap angle of less than 360°, in particular between 90° and 330°, further in particular between 180° and 300°, relative to a center point of the light channel. This ensures that the powdered filler material flowing out of the injectors 16, which are inserted in the injector guides 19, only interacts with the primary beam 111. The secondary beam 112 can thus form a process zone independent of the primary beam 111. The powder portion 11 and the advance portion 12 form a slotted hole shape when viewed from above. This also helps to reduce or avoid the imperfections identified at the outset.

FIG. 6 shows the jet nozzle 1 in a top view of the flange portion 9. The cross-sectional area of the light channel 3, which is orthogonal to the longitudinal direction of the jet nozzle 1, also deviates from a circular shape in the region of the flange portion 9 and is stretched in the advance direction 2. The elongation of the cross-sectional area can decrease from the distal region 8 to the flange portion 9. In the region of the nozzle mouth 6, the cross-sectional area can be stretched in such a way that it is at least 1.5 times larger in the advance direction, in particular at least twice as large as transverse to the advance direction. The flange portion 9 has such a radial extension that the injector guides 19 are not visible from the top view of the proximal region 10.

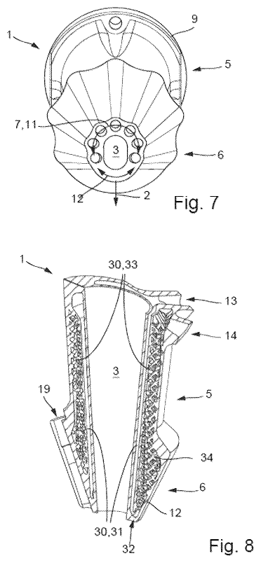

FIG. 7 shows the jet nozzle 1 in a further perspective view. The nozzle mouth 6 has a curved funnel shape. The injector guides 19, into which the powder injectors 16 can be inserted, are formed within the individual curvatures. In the advance direction 2, the light channel is stretched in a way that deviates from a circular shape to achieve the advantages according to the disclosure. In the peripheral direction around the light channel 3, the nozzle mouth 6 has the powder unit 7. This extends in the peripheral direction around the light channel 3 along the powder portion 11, which is adjoined by the powder-free advance portion 12.

FIG. 8 shows a perspective sectional view of the jet nozzle 1. The light channel 3 has a conical shape, so that the cross-sectional area of the light channel 3 running orthogonal to the longitudinal direction of the jet nozzle 1 is smaller in the distal region 8 than in the proximal region 10. The coolant inlet 13 and the coolant outlet 14 are arranged in the proximal region 10 of the jet nozzle 1 and protrude in the radial direction from the jet nozzle 1. FIG. 8 shows a sectional view of an injector guide 19. This is arranged in the powder portion 11. No injector guide 19 for powder jet guidance is provided in the advance portion 12. The jet nozzle 1 has a cooling system 30. A cooling medium, for example water, is fed back to a radially inner cooling chamber 31 via the coolant inlet 13 in the proximal region 10. The cooling medium can be distributed in the proximal region 10 in the peripheral direction around the light channel 3. The cooling medium runs from the proximal region 10 to the nozzle mouth 6. The radially inner cooling chamber 31 is formed at least in the nozzle mouth 6. It can extend from the distal region 8 to the proximal region 10 and be designed in the form of an annular gap segment that extends around light channel 3. In the region of the nozzle mouth 6, the radially inner cooling chamber 31 extends in the peripheral direction around the light channel 3. The radially inner cooling chamber 31 has a constant width in the radial direction in the region of the nozzle mouth 6 and is concentric to the light channel 3 in a cross-sectional area running orthogonally to a longitudinal direction of the jet nozzle 1.

A transition 32 between the radially inner cooling chamber 31 and a radially outer cooling chamber 33 is provided in the distal region 8. The radially outer cooling chamber 33 has a radial width that decreases towards the distal region 8 in the radial direction in the region of the nozzle mouth 6. The radially outer cooling chamber 33 extends from the distal region 8 to the proximal region 10, where it feeds the heated coolant to the coolant outlet 14. The transition 32 between the radially inner cooling chamber 31 and the radially outer cooling chamber 33 is arranged in the advance portion 12. The advance portion 12 has no injector guides 19 for guidance of the powder jet beam, which means that there is sufficient installation space for the transition 32.

The radially outer cooling chamber 33 has a cooling structure to increase the surface area. The cooling structure can be produced by means of an additive manufacturing process. It ensures that the cooling medium comes into contact with as much surface area as possible when returning from the distal region 8 to the proximal region 10 to promote heat dissipation. The cooling structure is optimized to cause the lowest possible pressure loss of the cooling medium. This may be achieved by a honeycomb structure 34, as shown in FIG. 8.

FIG. 9 shows the jet nozzle 1 in a top view of the distal region 8. The primary beam 111 and the secondary beam 112 are guided within the light channel 3. The secondary beam 112 is in front of the primary beam 111 in the advance direction 2 and does not interact with a powder caustic, as described in more detail in connection with FIG. 5. When the laser beams interact with the material surface and the powder jet, a vapor plume can form between the jet nozzle 1 and the workpiece 100. If this is not contained, it can interact with at least one laser beam and/or the unprocessed and/or processed material surface in an undesirable manner. In the region adjacent to the powder portion 11, the advance portion 12 may therefore be designed as a process-gas portion 61. This is formed by the process-gas unit 60 being arranged radially outside the light channel 3, which directs the process gas onto the workpiece. The process-gas portion 61 can prevent undesired spreading of the vapor plume and thus contribute to precise workpiece processing with a robust jet nozzle design. The process-gas portion 61 can form at least one, in the present case three, outlet openings 62. The outlet openings 62 are formed on one end face of the jet nozzle 1. An additional injector for supplying the process gas without filler material can be inserted into the respective outlet opening 62. An inner diameter of the outlet opening 62 can be smaller than an inner diameter of the injector guides 19. The process-gas portion 61 also prevents powder particles from adhering to the end face of the jet nozzle 1. In this respect, the process-gas portion 61 also increases the service life of the jet nozzle 1. The process-gas portion 61 and the powder portion 11 can be provided peripherally around the slotted hole formed by the light channel 3. Thus, the primary beam 111 and the secondary beam 112 are completely within the beams composed of the powder jet and the process gas jet.

A gas flow rate of process gas through the outlet openings 62 can be in the range between 1 l/min and 100 l/min, in particular between 5 l/min and 50 l/min. The gas flow rate of conveying gas flowing out of the injectors 16 or the injector guides 19 and of process gas flowing out of the outlet openings 62 can be substantially equal. It is also possible for process gas to exit the light channel 3 in addition to the outlet openings 62. The gas flow rates of the conveying gas and the process gas may also be weighted against each other. For example, the proportion of conveying gas may be greater than that of process gas or vice versa. The respective ratio of process gas to conveying gas can be adjusted depending on the process.

FIG. 10 shows the view from FIG. 9, in which a wrap angle 26, along which the powder portion 11 extends around the center point 20 of the light channel 3, is illustrated. In this case, the wrap angle 26 extends to 240°. The remaining 120° for the complete enclosure of the light channel 3 is formed in this case by the process-gas portion 61. Thus, the powder jet and the process gas jet completely surround the light channel 3. The powder injectors 16 or the injector guides 19 are designed such that the powder jet emerging therefrom is focused at the first powder focus 21. The primary beam 111 has a beam center point that coincides with a first powder focus 21 and forms a powder caustic. The primary beam 111 and the secondary beam 112 are offset from one another in the advance direction 2. The secondary jet 112 does not interact with the powder caustic. The process-gas portion 61 prevents the escape of a vapor plume and the adhesion of powder particles to the front side of the jet nozzle 1.

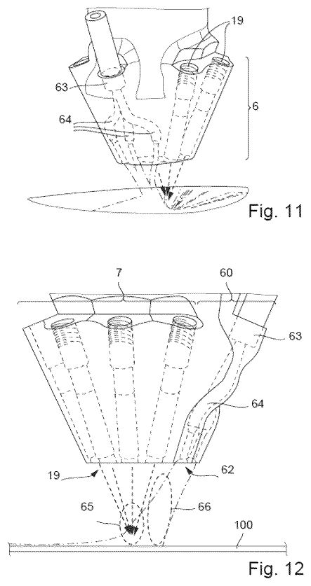

FIG. 11 shows a perspective view of the jet nozzle 1. A feed opening 63 is provided in the process-gas portion 60. The feed opening 63 is arranged in the region of the nozzle mouth 6 facing away from the workpiece. Process gas is supplied to the process-gas portion 60 via the same. Starting from the one feed opening 63, the process gas can be guided to the individual outlet openings 62 through distribution arms 64, which are formed within the process-gas portion 60. The number of distribution arms 64 corresponds to the number of outlet openings 62. The distribution arms 64 extend within the process-gas unit 60 along the nozzle mouth 6 to distribute the process gas from the feed opening 63 to the outlet openings 62. The distribution arms 64 may form sections, into which additional injectors can be inserted. These may allow the process gas to exit at an angle relative to the workpiece surface. The distribution arms 64 are designed in such a way that the process gas can be directed at the workpiece surface efficiently and in a process-appropriate manner.

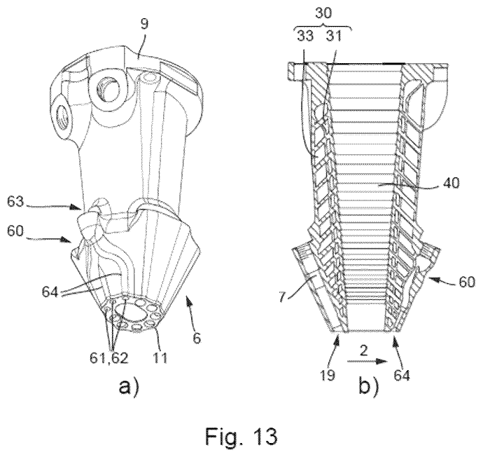

FIG. 12 shows the jet nozzle 1, the workpiece 100 and the area therebetween in a side view. The powder unit 7 extends in such a way that the powder jet can be directed from the powder portion 11 of the nozzle mouth 6 onto the workpiece 100 in a process-compliant manner. The powder unit 7 is followed by the process-gas unit 60, which guides the process gas from the feed opening 63 via the distribution arms 64 to the outlet opening 62, so that the process gas can be directed at the workpiece from the process-gas portion 61 of the nozzle mouth 6 in a process-appropriate manner. The interaction between the primary jet 111, the powder jet and the workpiece surface causes a first vapor plume 65. The interaction between the secondary jet 112 and the material surface causes a second vapor plume 66. The process gas flows from the outlet openings 62 in such a way that the first vapor plume 65 and the second vapor plume 66 do not exit radially from the extended region of the light channel 3.

FIG. 13 shows the jet nozzle 1 in three different views. FIG. 13 a) is a perspective view. In the area of the nozzle mouth 6 facing the flange portion 9, the feed opening 63 is provided in the process-gas unit 60. This represents the central interface through which process gas is made available to the nozzle mouth 6. Starting from the feed opening 63, the process gas is distributed along the distribution arms 64, which distribute the process gas from the feed opening 63 along the peripheral direction around the light channel 3. The outlet openings 62, from which the process gas exits towards the workpiece, are at the distal end of the distribution arms 64. The outlet openings 62 are part of the process-gas portion 61 and they extend in an arcuate shape along the peripheral direction around the light channel 3. The powder portion 11 adjoins it in a horseshoe shape. Thus, in the present example, the light channel 3 is completely surrounded, i.e., 360°, by the powder portion 11 and the process-gas portion 61.

FIG. 13 b) is a sectional view. The powder unit 7 is provided at a rear region in the advance direction 2, which forms the powder portion 11 and through which the injector guides 19 extend. The injector guides 19 are adapted to each accommodate a powder injector 16. The process-gas unit 60 is provided at a front region in the advance direction 2, which forms the process-gas portion 61 and through which distribution arms 64 extend. A distribution arm 64 may accommodate an additional injector. Alternatively, the process gas is directed directly from the distribution arms 64 to the material surface. The distribution arms 64 have a curved shape along their longitudinal direction. The jet nozzle 1 has the cooling system 30 with the radially inner cooling chamber 31 and the radially outer chamber 33. Due to the embodiment of the advance portion 12 as a process-gas portion, the radially outer cooling chamber 33 surrounds the distribution arms 24 in the front region of the nozzle mouth 6 in the advance direction 2. The process gas may therefore contribute to the heat management of the jet nozzle 1.

The jet nozzle 1 has an absorption portion 40 on the lateral surface 4 of the light channel 3 for receiving a reflection radiation of the laser beam from the workpiece 100. The absorption portion 40 may have a geometry that facilitates the absorption of the reflected radiation. The absorption portion may extend variably in a peripheral direction around the light channel 3, in particular may be configured to extend over the entire circumference of the light channel 3. It may also extend variably in a longitudinal direction of the light channel 3. In particular, no absorption portion 40 is formed in the distal lateral surface of the nozzle mouth 6, but rather a smooth inner end portion in order to be able to better clean the inside of the nozzle mouth 6. The shape of the absorption portion 40 can be adapted to the expected back-reflected radiation. The absorption portion 40 can be formed of the same material as the rest of the jet nozzle. It may also have a coating. The laser radiation absorbed by the absorption portion 40 can be at least partially dissipated by the cooling system 30. The back-reflected radiation is absorbed by the absorption portion 40 in such a way that the portion of radiation that penetrates into other components of the laser system, such as the laser optics, is reduced or eliminated. This increases process reliability and the precision of the laser beam. The service life of the jet nozzle 1 and the laser system is also increased. The improved properties of the jet nozzle 1 due to the absorption surface enable welding behavior without the aforementioned imperfections.

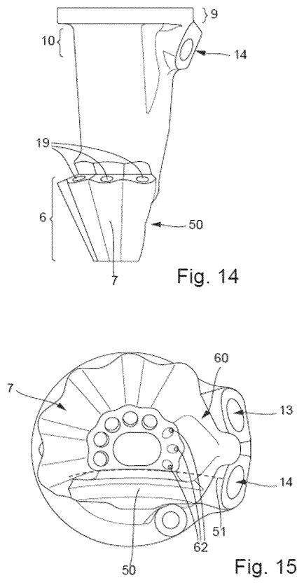

FIG. 14 shows a further embodiment of the jet nozzle 1. The nozzle mouth 6 has a chamfer 50, through which a part of the nozzle mouth 6 is cut off. The chamfer 50 has the effect that the powder portion 11 and the advance portion 12 without a powder portion, which selectively form the process-gas unit 60, are cut off in the peripheral direction around the light channel 3. The chamfer 50 reduces the volume of the nozzle mouth 6 compared to the embodiment in which there is no chamfer 50. This ensures that the nozzle mouth 6 takes up less installation space. The jet nozzle 1 with the chamfer 50 may be used, for example, to coat a brake disk. The brake disk may have a mount that protrudes axially from the functional surface to be coated. The chamfer 50 ensures that the jet nozzle 1 can move flexibly on the functional surface to be coated and can be moved close to the holder. The chamfer 50 may be substantially flat and run in a plane that is inclined relative to the longitudinal direction of the jet nozzle. The chamfer 50 represents a boundary surface of the nozzle mouth 6 in which a powder unit 7 is not provided. In the distal region 8, the chamfer 50 is arranged so close to the light channel 3 that no injector guides 19 or additional injectors are provided on an end face of the jet nozzle 1 facing the workpiece in the region of the chamfer 50.

FIG. 15 shows the jet nozzle 1 with the chamfer 50 in a top view. The chamfer 50 may run in the distal region 8 in the manner of a passant 51 on the slotted hole. The passant 51 defines the orientation of the chamfer 50 on the nozzle mouth 6. The passant 51 runs along a straight line or an extended arc on the end face of the jet nozzle 1 facing the workpiece, without cutting through or touching the slotted hole. The distance of the passant 51 from the center point 20 of the light channel 3 is greater than the distance of the corresponding portion of the slotted hole from the center point 20 of the light channel 3. The distance between the passant 51 and an outer edge of the slotted hole is selected in such a way that the wall thickness therebetween ensures sufficient strength and load capacity of the jet nozzle 1.

The orientation of the passant 51 and thus the orientation of the chamfer 50 at the nozzle mouth 6 can be varied for different jet nozzles 1 depending on the respective application. For example, the passant 51 can run in the advance direction 2. In this case, the passant 51 runs along the extension of the cross-sectional area of the light channel 3. The passant 51 thus runs along the long side of the slotted hole. Alternatively, the passant 51 can run transversely to the advance direction 2, for example. In this case, the passant 51 runs transversely to the extension of the cross-sectional area of the light channel 3. The passant 51 thus runs along the partial circular section of the slotted hole. Further alternatively, the passant 51 can, for example, run at an angle to the advance direction 2 that lies between a course along the advance direction 2 and transverse to the advance direction 2. In this case, the passant 51 runs along the transition section between the long side of the slotted hole and the partial circular section of the slotted hole. The course of the passant 51 determines the orientation of the chamfer 50.

In the embodiment in FIG. 15, outlet openings 62 are provided on the front side of the jet nozzle. From here, the process gas exits the process-gas unit 60. In the present case, the chamfer 50 is such that the portion of the nozzle mouth 6 cut off by it originates entirely from the powder portion 11, so that the angle along which the powder portion 11 extends is reduced by the chamfer 50, while the angle along which the process-gas unit 60 extends remains substantially the same.

Insofar as applicable, all individual features presented in the exemplary embodiments can be combined with one another and/or interchanged.

### LIST OF REFERENCE SYMBOLS

1 Jet nozzle
2 Advance direction
3 Light channel
4 Lateral surface
5 Outer structure
6 Nozzle mouth
7 Powder unit
8 Distal region
9 Flange portion
10 Proximal region
11 Powder portion
12 Advance portion
13 Coolant inlet
14 Coolant outlet
15 Coupling ring
16 Powder injector
17 Inlet connection
18 Outlet connection
19 Injector guide
20 Center point of the light channel
21 First powder focus
26 Wrap angle
30 Cooling system
31 Radially inner cooling chamber
32 Transition
33 Radially outer cooling chamber
34 Honeycomb structure
40 Absorption portion
50 Chamfer
51 Passant
60 Process-gas unit
61 Process-gas portion
62 Outlet opening
63 Feed opening
64 Distribution arm
65 First vapor plume
66 Second vapor plume
100 Workpiece
110 Laser beam
111 Primary beam
112 Secondary beam
120 Powdered filler material
130 Weld pool
140 Functional layer

1. A jet nozzle for laser deposition welding in an advance direction, the jet nozzle comprising:
a light channel for guiding at least one laser beam to be directed at a workpiece;
a powder unit arranged radially outside the light channel for guiding at least one powder jet to be applied to the workpiece, wherein the powder unit forms a powder portion in a peripheral direction around the light channel; and
a process-gas unit arranged radially outside the light channel for guiding a process gas, wherein the process-gas unit forms a process-gas portion in the peripheral direction;
wherein the process-gas portion adjoins the powder portion at a nozzle mouth in the peripheral direction.

2. The jet nozzle according to claim 1, wherein
the process-gas unit forms at least one outlet opening on one end face of the jet nozzle, from which the process gas is capable of being fed to the workpiece, wherein an additional injector for supplying the process gas without filler material is arranged in the at least one outlet opening.

3. The jet nozzle according to claim 1, wherein
the process-gas portion extends at least in sections along an arc of a slotted hole, in an arcuate shape, around the light channel.

4. The jet nozzle according to claim 1, wherein
the powder portion extends in the peripheral direction around the light channel over a wrap angle of between 5° and 180°, relative to a center point of the light channel.

5. The jet nozzle according to claim 1, wherein
the process-gas portion and the powder portion together completely surround the light channel in the peripheral direction.

6. The jet nozzle according to claim 1, wherein
the process-gas unit has a feed opening, through which the process gas is capable of being supplied to the process-gas unit, and at least one outlet opening, through which the process gas exits the process-gas unit.

7. The jet nozzle according to claim 6, wherein
the process-gas unit has a plurality of outlet openings, each of which being connected to the one feed opening.

8. The jet nozzle according to claim 1, wherein
the process-gas portion is formed in a region of the nozzle mouth facing the advance direction.

9. The jet nozzle according to claim 1, wherein
the powder portion has a plurality of injector guides, into each of which a powder injector is capable of being inserted.

10. The jet nozzle according to claim 9, wherein
an inner diameter of the at least one outlet opening is smaller than an inner diameter of the injector guides.

11. The jet nozzle according to claim 9, wherein
a first powder injector is prepared to convey a first powder mass flow and a second powder injector is prepared to convey a second powder mass flow, wherein the first powder mass flow differs from the second powder mass flow.

12. The jet nozzle according to claim 1, wherein
the powder portion forms an annular gap segment.

13. The jet nozzle according to claim 1, wherein
the light channel is adapted to guide a plurality of laser beams, wherein the plurality of laser beams comprises a first laser beam as a primary beam and a second laser beam as a secondary beam.

14. The jet nozzle according to claim 1,
wherein the jet nozzle is manufactured by an additive manufacturing process.

15. The jet nozzle according to claim 1 wherein
the nozzle mouth has a chamfer, by which a part of the nozzle mouth is cut off, wherein the chamfer is substantially planar and extends in a plane that is inclined relative to a longitudinal direction of the jet nozzle.
